(19) United States
(12) Patent Application Publication
(10) Pub. No.: US 2006/0280217 A1
(43) Pub. Date: Dec. 14, 2006

(54) Optical apparatus, comprising a brightness converter, for providing optical radiation

(75) Inventors: Mikhail Nicholaos Zervas, Hill Farm Road (GB); Malcolm Paul Varnham, Hampshire (GB)

Correspondence Address: John S Reid;Reidlaw, 1926 S Valleyview Lane, Spokane, WA, 99212-0157, US

(73) Assignee: SPI Lasers UK Ltd.

(21) Appl. No.: 10/560,318

(22) PCT Filed: Jun. 11, 2004
(86) PCT No.: PCT/GB04/02535

§ 371 Date: May 9, 2006

(30) Foreign Application Priority Data
Jun. 12, 2003 (GB) 0313592.8
Oct. 9, 2003 (GB) 0323663.5

(51) Int. Cl. H01S 3/30; H01S 3/094; H01S 3/091; H01S 3/093; H01S 3/092

(52) U.S. Cl. 372/72; 372/6; 372/70; 372/75

(57) ABSTRACT

Apparatus for providing optical radiation (10), which apparatus comprises a pump source (1) for providing pump radiation (2), and a brightness converter (3), the apparatus being characterised in that the brightness converter (3) includes a substantially rigid region along at least a portion of its length.

### FIELD OF INVENTION

This invention relates to an apparatus for providing optical radiation. The invention can take various forms, for example a laser, a Q-switched fibre laser, a master oscillator power amplifier, or a laser that contains a frequency converter. The invention has application for materials processing.

### BACKGROUND TO THE INVENTION

Pulsed Neodymium doped Yttrium Aluminum Garnet (Nd:YAG) lasers are widely used in industrial processes such as welding, cutting and marking. Care has to be taken in these processes to ensure that the plasmas generated by the laser does not interfere with the incoming laser pulses. The relatively low pulse repetition rates (6 kHz) it high peak powers that are achievable in a NdYAG laser have led to their wide application in laser machining. The most common format for Nd:YAG lasers are so-called rod lasers in which the Nd:YAG is formed in a rod and is pumped either by lamps or by laser diodes. A disadvantage of rod lasers is the degradation of beam quality as the output power is increased. This is because of “thermal lensing” within the Nd:YAG crystal. Thermal lensing becomes important for output powers in excess of 500 W. The beam quality can be defined in terms of the beam parameter product, which is the beam radius in mm at the beam waist multiplied by the (half-angle) divergence angle in mrad. Typical values for beam parameter products are 25 mm·mrad for a 6 kW lamp-pumped Nd:YAG laser, and 12.5 mm·mrad for a 6 kW diode-pumped Nd;YAG laser. Lasers having such power levels and beam parameters are widely used in welding applications.

Much work has been undertaken to improve high-power laser performance in terms of beam parameter and reliability. Yttrium doped Yttrium Aluminium Garnet (Yb:YAG) is one of the most promising laser-active materials and more suitable for diode-pumping than the traditional Nd-doped crystals. It can be pumped at 0.94 μm and generates 1.03 μm laser output. Compared with the commonly used Nd:YAG crystal, Yb:YAG crystal has a larger absorption bandwidth in order to reduce thermal management requirements for diode lasers, a longer upper-state lifetime, three to four times lower thermal loading per unit pump power. Yb:YAG crystal is expected to replace Nd:YAG crystal for high power diode-pumped lasers and other potential applications.

Changing from rods to disks has been demonstrated to provide a route towards increasing the beam quality. Disk lasers contra several Yb:YAG disks of several mm thickness can be designed to have a beam parameter product of around 8 mm·rad thus making the lasers suitable for both welding and some cutting applications. The disks have a diameter of 5 to 10 mm in order to facilitate efficient coupling from laser diodes. A disadvantage of the disk laser is that a long optical path needs to be provided external to the disks in order to achieve the required beam quality. Provision of such a long optical path results in a laser that is difficult to design and make, and also a laser that is susceptible to environmental disturbance, such as temperature changes and vibration.

Fibre lasers are increasingly being used for materials processing applications such as welding, cutting and marling. Their advantages include high efficiency, robustness and high beam quality. These advantages arise because the laser cavity is formed in a waveguide. Examples include femtosecond lasers for multiphoton processing such as the imaging of biological tissues, Q-switched lasers for machining applications, and high-power continuous-wave lasers. In many applications, fibre lasers need to compete with the more mature diode pumped solid state lasers. In order to do so, much greater optical powers need to be achieved, with high reliability and lower cost.

Fibre lasers are typically longer than diode-pumped solid state lasers, and this leads to non-linear limitations such as Raman scattering becoming problematical. It would be advantageous to have fibre lasers that are shorter.

Fibre lasers are typically plumped with diode lasers in bar or stack form. The output from bars and stacks is not ideally matched to the geometry of fibre lasers, leading to a loss in brightness. The loss in brightness results in the need to supply the pump radiation into the cladding of the fibre laser, and this increases the length of cladding pumped fibre lasers in order to obtain the necessary absorption and output energy. High power fibre lasers can be 5 m to 10 m long, and are typically formed in fibres having diameters in the range 100 μm to 500 μm.

An aim of the present invention is to provide apparatus for providing optical radiation that reduces the above aforementioned problems.

### SUMMARY OF THE INVENTION

According to a non-limiting embodiment of the present invention, there is provided apparatus for providing optical radiation, which apparatus comprises a pump source for providing pump radiation, and a brightness converter, the apparatus being characterised in that the brightness converter contains a substantially rigid region along at least a portion of its length.

An advantage in providing a brightness converter that is substantially rigid along at least a portion of its length is that good beam quality (a beam parameter product less than 12.5 mm·mrad, combined with high power (greater than 500 W, and preferably greater than 5 kW) can be achieved in a solid state laser having relatively stiff member. It also provides a route to achieving beam parameter products less than 8 mm·mrad, and preferably less than 5 mm·mrad.

The invention is counter-intuitive in that it is the complete opposite solution that has been provided to date with fibre lasers in which the optical fibre used to form the fibre laser is in the for of a fibre. The optical fibre of prior art fibre lasers is flexible.

One aspect of the present invention is to replace the Nd:YAG or Yb:YAG rod with a relatively thick (>1 mm, and preferably greater than 2 mm in at least one cross-sectional dimension) optical fibre waveguide having a core and a cladding. The resulting design can provide output power levels at levels comparable to diode-pumped Nd:YAG lasers with the beam quality of the disk laser, and this without the environmental sensitivity of the disk laser. In other words, fibre optic technology can solve the thermal lensing problem that occurs in rod lasers and this has advantages over replacing the rod with a disk made of the same or similar material.

The brightness converter may comprise a core, a first cladding, rare earth dopant, a first end, and a second end. The brightness converter may comprise a tapered region located between the first end and the second end, the apparatus being characterised in that the cross-sectional area of the first end is greater than the cross-sectional area of the second end, and the brightness converter is substantially rigid between the first end and the tapered region.

An advantage of the tapered region is that it can be used to increase the beam quality of the laser output while retaining the first end having a relatively large surface area—ideal for launching optical pump power having lower beam quality than the laser output.

The apparatus is particularly useful for increasing the brightness of the pump radiation via absorption into the rare earth dopant and wavelength conversion into modes guided by the core.

The pump radiation may be coupled from the pump source into the brightness converter using a coupling means. The coupling means may be a lens such for example as a cylindrical lens.

The apparatus may comprise a first reflector for reflecting optical radiation emerging from the first end. The apparatus may also comprise a second reflector.

The pump source may comprise at least one laser diode, laser diode bar, laser diode stack, or a laser diode mini-bar stack. Alternatively or additionally, the pump source may include a solid-state laser, a gas laser, an arc lamp, or a flash lamp.

The apparatus may comprise a plurality of the pump sources, and a combining means for combining the pump radiation emitted by the pump sources. The combining means may comprise a beam splitter, a reflector, a polarisation beam combiner, a beam shaper, a wavelength division multiplexer, or a plurality of optical fibres in optical contact along at least a portion of their length.

The brightness converter may have multiple cores, or a single core. The brightness converter may be circular or non-circular. The brightness converter may have a cross-section that is rectangular, is a regular or irregular shaped polygon, or is D-shaped.

The brightness converter may comprise rare-earth dopant. The rare-earth dopant may be disposed in the core and/or the first cladding. The rare earth dopant may be selected from the group comprising Ytterbium, Erbium, Neodymium, Praseodymium, Thulium, Samarium, Holmium, Dysprosium, Erbium codoped with Ytterbium, or Neodymium codoped with Ytterbium.

The brightness converter may comprise a second cladding.

The apparatus may comprise a waveguide that is pumped by the brightness converter. The brightness converter may be doped with neodymium and/or ytterbium. The waveguide may be doped with ytterbium erbium, or erbium co-doped with ytterbium.

The brightness converter may be defined by a width. The width may be in the range 0.1 mm to 100 mm. The width may be in the range 0.2 mm to 25 mm. Preferably the width is in the range 5 mm to 15 mm.

The brightness converter may be defined by a bread. The breadth may be in the range 0.1 mm to 100 mm. The breadth may be in the range 0.2 mm to 25 mm. Preferably the breadth is in the range 2 mm to 15 mm.

The brightness converter may be defined by a length. The length may be in the range 1 mm to 2000 mm. The length may be in the range 10 mm to 200 mm. Preferably the length is in the range 10 mm to 50 mm.

The brightness converter can be formed from an optical fibre preform. The preform can be made from silica, silicic, phosphate or phosphatic glass. The preform may contain longitudinally extended holes. The preform may include stress rods.

The apparatus may be in the form of a laser, a Q-switched fibre laser, a master oscillator power amplifier, or a laser that contains a frequency converter.

### BRIEF DESCRIPTION OF THE DRAWINGS

Embodiments of the invention will now be described solely by way of example and with reference to the accompanying drawings in which:

FIG. 1 shows apparatus for providing optical radiation according to the present invention;

FIG. 2 shows apparatus comprising a plurality of pump sources;

FIGS. 3 to 5 show examples of brightness converters;

FIG. 6 shows apparatus in which the brightness converter has been drawn down to a fibre;

FIG. 7 shows apparatus comprising a waveguide;

FIG. 8 shows apparatus comprising an intermediate fibre;

FIG. 9 shows apparatus in the form of a Q-switched laser comprising a Q-switch;

FIG. 10 shows a cross-section of the brightness converter of FIG. 9;

FIG. 11 shows apparatus in the form of a master oscillator power amplifier;

FIG. 12 shows apparatus in the form of a master oscillator power amplifier, which utilizes the brightness converter to pump a waveguide;

FIG. 13 shows apparatus in the form of a laser that comprises a frequency converter within the cavity;

FIG. 14 shows apparatus in which a plurality of pump sources have been combined by a plurality of optical fibres in a common coating;

FIG. 15 shows a cross section of the optical fibres in a common coating described with reference to FIG. 14;

FIG. 16 shows a preferred embodiment of the invention;

FIG. 17 shows a cross-section of a beam converter in which the cores are arranged in a row;

FIG. 18 shows a composite beam profile; and

FIG. 19 shows the cross-section of an optical fibre intended for delivery to the point of use.

### DETAILED DESCRIPTION OF PREFERRED EMBODIMENTS OF THE INVENTION

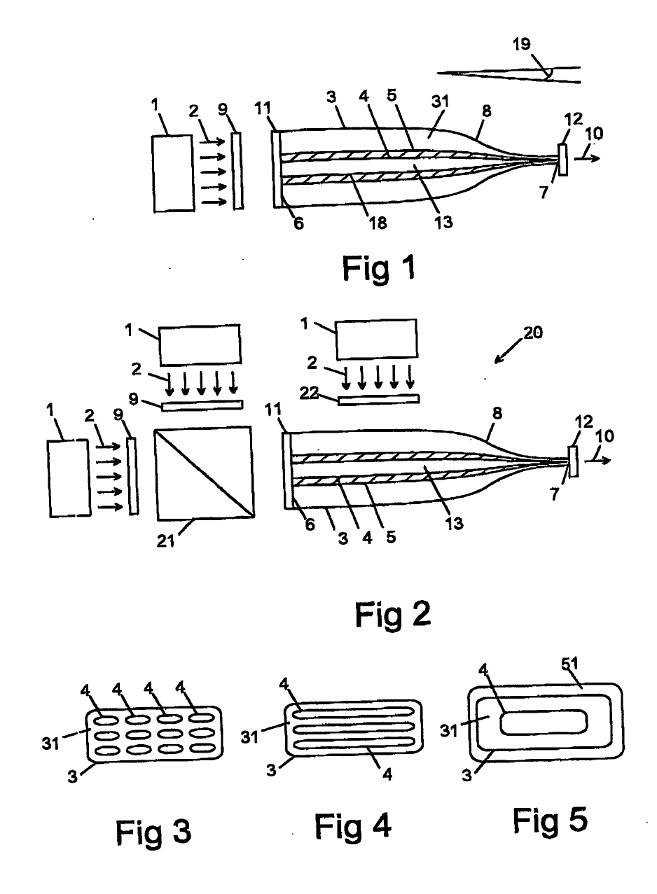

Referring to FIG. 1, there is provided apparatus for providing optical radiation 10, which apparatus comprises a pump source 1 for providing pump radiation 2, and a brightness converter 3, the apparatus being characterised in that the brightness converter 3 includes a substantially rigid region along at least a portion of its length.

An advantage in providing a brightness converter that is substantially rigid along at least a portion of its length is that good beam quality (a beam parameter product less than 12.5 mm·mrad, combined with high power (greater than 500 W, and preferably greater than 5 kW) can be achieved in a solid state laser having relatively stiff member. It also provides a route to achieving beam parameter products less than 8 mm·mrad, and preferably less than 5 mm·mrad.

The brightness converter 3 comprises a core 4, a first cladding 31, rare earth dopant 5, a first end 6, a second end 7, and a tapered region 8 located between the first end 6 and the second end 7, the apparatus being characterised in that the cross-sectional area of the first end 6 is greater than the cross-sectional area of the second end 7, and the brightness converter 3 is substantially rigid between the fist end 6 and the tapered region 8.

Preferably, the tapered region 8 should be sufficiently long that optical radiation 10 does not suffer loss as it propagates along the tapered region 8. In other words, it is preferably that the tapered region 8 is an adiabatic taper. The brightness converter 3 can be defied by a numerical aperture 18 between the core 4 and the first cladding 31. The angle subtended by the tapered region 8 at the interfaced between the core 4 and the first cladding 31 should be less than the numerical aperture 18. Thus if the numerical aperture 18 is 0.1, the angle 19 subtended by the tapered region 8 should be less than 0.1 rad (or 100 mrad). Preferably the angle 19 should be between two to ten times smaller than the numerical aperture 18. An advantage of an adiabatic taper is that the brightness converter 3 will have all the advantages provided by a relatively large cross-sectional area (greater than 2 mm², or preferably greater than 10 mm²) of its first end 6 which facilitates launching of pump radiation 2, while providing a mechanism for achieving higher beam quality by for example arranging feedback of the optical radiation 10 from the second end 7 in order to form a laser cavity.

The apparatus is particularly useful for increasing the brightness of the pump radiation 2 via absorption into the rare earth dopant 5 and wavelength conversion into modes guided by the core 4. The apparatus can be such that the optical radiation 10 has a higher brightness than the pump radiation 4.

The pump radiation 2 is coupled from the pump source 1 into the brightness converter 3 using a coupling means 9. The coupling means 9 may be a lens such as a cylindrical lens.

The apparatus comprises a first reflector 11 to reflect optical radiation 10 emerging from the first end 6. The apparatus also comprises a second reflector 12. The second reflector 12 is configured to reflect optical radiation 10 emerging from the second end 7. The first and second reflectors 11, 12 form a laser cavity 13. Preferably, the reflectivity of the first reflector 11 is greater than the reflectivity of the second reflector 12 at the wavelength of the optical radiation 10. The first reflector 11 can be a mirror, a dichroic mirror, a dielectric mirror, a reflector or a grating. The second reflector 12 can be a mirror, a dichroic mirror, a dielectric mirror, a reflector, a grating, or a Bragg grating such as a fibre Bragg grating. The second reflector 12 can alternatively be formed by the few percent reflection from a dielectric (such as glass) and air interface.

The pump source 1 can be a laser diode, a laser diode bar, a laser diode stack or a laser diode mini-bar stack. A laser diode stack is a stack of diode bars with each bar typically containing ten to nineteen laser diode stripes (or even more), whilst a mini bar stack would typically contain a stack of diode bars with each diode bar containing two to nine laser diode stripes. A laser diode mini-bar stack is especially useful because it allows pump light to be coupled into optical fibres having diameters in the range 100 μm to 5000 μm with the advantage that beam shapers can be avoided. Arranging mini-bars into stacks and coupling the pump radiation into optical fibres is new and provides important economic advantages over the prior art. Alternatively or additionally, the pump source 1 can be a solid-state laser, a gas laser, an arc lamp, or a flash lamp.

FIG. 2 shows apparatus in the form of a laser 20. The laser 20 comprises three pump sources 1, a combining means 21 and a coupling means 22. The coupling means 22 may be a lens such as a cylindrical lens. The combining means 21 can be a beam splitter.

The combining means 21 may contain reflectors to combine the pump radiation 2 from a plurality of pump sources 1. The combining means 21 may be a beam splitter. The pump sources 1 may be laser diode stacks. The reflector may be a striped reflector for interleaving the pump radiation 2 from the laser diode stacks.

The combining means 21 can be or can include a polarisation bean combiner, which is advantageous for polarisation multiplexing.

The combining means 21 and/or the coupling means 22 can also include one or more beam shapers such as are described in U.S. Pat. Nos. 5,243,619, 5,557,475, 5,825,551, 6,005,717, 6,151,168, 6,229,940, 6,240,116, RE 33,722, which patents are hereby incorporated herein.

The combining means 21 can be or can include a wavelength division multiplexer configured to combine the pump radiation 2 from two pump sources 1 having different wavelengths.

Beam combining, interleaving, polarisation multiplexing, and wavelength division multiplexing can be used to couple the pump radiation 2 from two to four, or more, pump sources 1 into the brightness converter 3.

FIGS. 3, 4 and 5 show examples of the cross-sections at the first end 6 of the brightness converter 3. The brightness converter 3 can have multiple cores 4, or a single core 4. Although the brightness convey 3 can be circular, a non-circular cross-section can provide greater coupling between cladding modes and modes guided in the cores 4 as is described more fully in U.S. Pat. No. 4,815,079 which is hereby incorporated by reference herein. The brightness converter 3 can have a cross-section that is rectangular, is a regular or irregular shaped polygon, or is D-shaped. The refractive index of the core 4 is preferably greater than the refractive index of the first cladding 31. The rare-earth dopant 5 can be disposed in the core 4 and/or the first cladding 31. The rare earth doping 5 may be selected from the group comprising Ytterbium, Erbium, Neodymium, Praseodymium, Thulium, Samarium, Holmium, Dysprosium, Erbium codoped with Ytterbium, or Neodymium codoped with Ytterbium. The brightness converter 3 may include a second cladding 51 as shown with reference to FIG. 5. The refractive index of the second cladding 51 is preferably lower than the refractive index of the first cladding 31. The second cladding 51 may be a polymer. Alternatively the second cladding 31 can be a glass such as fluorine doped silica.

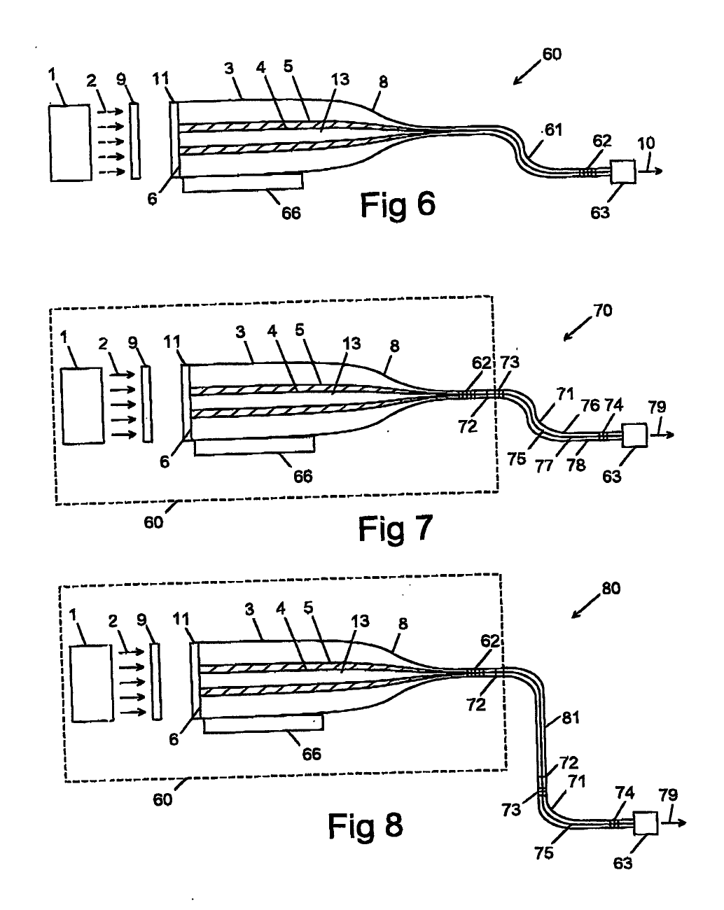

FIG. 6 shows apparatus in the form of a laser 60 in which the brightness converter 3 is drawn down to a fibre 61. The second reflector 12 is configured as a fibre Bragg grating 62 written in at least one of the core 4 or first cladding 31. An end cap 63 is shown in order to expand the optical radiation 10 prior to it leaving the fibre 61. This is advantageous to reduce the probability of damage at the fibre/air interface. The end cap 63 may be fused silica, which is preferably polished for example by laser polishing. The end cap 63 may be fused (eg by laser fusing) to the fibre 61. The end cap 63 may be antireflection coated.

A heat sink 66 is also shown for removal of heat from the brightness converter 3. The heat sink 66 can be air cooled or water cooled. Preferably the heat sink 66 is configured to provide two dimensional contact with the surface of the brightness converter 3. This can be achieved if the brightness converter 3 contains at least one flat surface as would be provided for example by the cross-sections shown in FIGS. 3 to 5. Alternatively or in addition, the brightness converter 3 may be cooled by surrounding it in fluid, which fluid is preferably flowing. The fluid may be a gas such as nitrogen or argon gas or may be a liquid such as water or oil, or a water glycol mixture suitable for operation in cold climates.

FIG. 7 shows apparatus in the form of a laser 70 in which the laser 60 is used to pump a waveguide 71 that comprises at least one core 75, at least one cladding 76, and a gain medium 77. The gain medium 77 can comprise at least one rare-earth dopant disposed in one or both of the core 75 and cladding 76. The laser 60 can be replaced with the apparatus shown in FIG. 1 or FIG. 2. The waveguide 71 can be core pumped or cladding-pumped. Core and cladding pumped fibre lasers are described further in U.S. Pat. Nos. 4,815,079, 6,288,835 and 6,445,494, which are hereby incorporated herein by reference. The waveguide 71 is shown coupled to the laser 60 by a splice 72. Alternatively, lenses can be used to couple the laser 60 to the waveguide 71. The waveguide 71 is shown as having a first and second fibre Bragg grating 73, 74 in order to form a laser cavity 78.

Advantages of the double pumping scheme shown in FIG. 7 includes better thermal distribution. Thus for example, if the gain medium 77 was based on erbium for operation at so-called eye-safe wavelengths (>1500 nm), then the laser 60 can be configured to emit optical radiation 10 in the wavelength range 1470 nm to 1550 nm by selecting first and second reflectors 11, 62 to reflect at a desired wavelength in the wavelength range 1470 nm to 1559 nm in order to pump the gain medium 77. The laser 60 can in turn be pumped by laser diodes in the wavelength rage 910 nm to 1060 nm (if the rare earth dopant 5 is erbium codoped with ytterbium) or by laser diodes in the wavelength range 974 nm to 976 nm (if the rare earth dopant is erbium). More heat will be dissipated in the beam combiner 3 than the waveguide 71 because the difference between pump wavelength and emission wavelength would be greater in the beam combiner 3 than in the waveguide 71. The double pumping scheme thus provides a method to manage the thermal dissipation in fibre lasers.

Another advantage of the double pumping scheme shown in FIG. 7 is that the brightens converter 3 provides a method of increasing the brightness of a pump source 1 for pumping the optical waveguide 71. This is particularly important if the waveguide 71 is single mode since it allows core pumping of the waveguide 71 from a pump source 1 that has a lower brightness than the optical radiation 10. Similarly, a singe mode or a multimode waveguide 71 that is cladding pumped can be made shorter if the pump radiation is higher brightness. This is because the length of a cladding pumped fibre laser that is required to achieve reasonable pump absorption (>50%) is dependant upon the ratio of the cross-sectional area of the waveguide 71 to the cross-sectional area of its core 75 (or if a plurality of cores 75 are used, of the combined cross-sectional tea of the cores 75). Advantages of shorter waveguides 71 include increasing the threshold of non-linear effects such as stimulated Raman scattering and stimulated Brillouin scattering, particularly for high-power continuous wave and pulsed lasers for both materials processing and aerospace application.

FIG. 8 shows apparatus in the form of a laser 80 that comprises an intermediate fibre 81 for transmission of the optical radiation 10 from the laser 60 to the waveguide 71. This is a particularly useful arrangement for use in materials processing applications (such as welding, drilling and cutting) because it allows separation of the pump source 1 from the waveguide 71 which can be located on or in the vicinity of, a machine tool. Advantages include location of the pump source 1 where the provision of services such as electrical power and chilled water are convenient and the ability to use optical switches to share the pump source 1 between several waveguides 71 which may be at different locations. Advantages also include a method to increase the susceptibility to undesirable non-linear effects such as stimulated Raman scattering and stimulate Brillouin scattering by transmitting relatively low brightness pump radiation over long distances (>10 m to 2 km) to the waveguide 71 which then outputs higher brightness optical radiation 79.

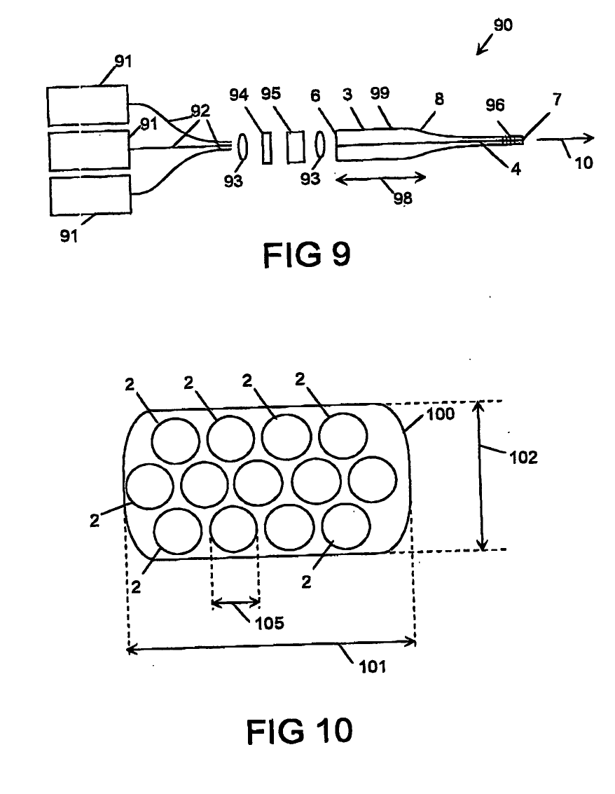

FIG. 9 shows apparatus in the form of a Q-switched laser 90 which comprises a plurality of laser diode modules 91 providing pump radiation 2 in optical fibre bundles 92. The pump radiation 2 from the fibre bundles 92 is imaged onto the brightness converter via the lenses 93, the dichroic mirror 94 and the Q-switch 95. The Q-switch 95 can be an acousto-optic modulator or an electro-optic modulator. The brightness converter 3 is formed from an optical fibre preform that has been necked down in to form the taper 8. The first end 6 preferably includes an anti-reflection coating. The second end 7 has a fibre Bragg grating 96 to reflect the laser radiation 10. The fibre bundles 92 can be replaced by individual fibres or lenses.

FIG. 10 shows a cross-section 100 of the first end 6 of the brightness converter 3 with the pump radiation 2 from the fibre bundles 92 that have been imaged onto its surface shown as individual spots having a diameter 105. The laser diode module 91 can be a FAP-B-60C-1200-BL Fiber Array Packaged Bar from Coherent Inc. of the United States of America. The laser diode module 91 can provide 60 W continuous wave power at 810 nm with a beam diameter of 1.2 mm with a numerical aperture of 0.16. Thus 780 W of pump radiation can be imaged onto the brightness converter 3 without any magnification if for example the brightness converter has cross-sectional dimensions of width 101 of 10 mm and breadth 102 of 5 mm. Increasing the magnification allows either a brightness converts 3 of lower cross-sectional area. Additionally or alternatively increasing the magnification would allow pump radiation from more laser diode modules 91 to be imaged. The numerical aperture of a brightness converter 3 made from silica and coated with a low index polymer can be 0.4. This would allow approximately 5 kW of pump radiation to be launched onto the first end 6 of the brightness converter 3 using these relatively low brightness sources 91. Even higher powers can be achieved with soft glasses that have a brighter refractive index.

If made using optical fibre preform technology, such a preform can be tapered down by a factor of around 100 (in linear dimensions) thus providing an output fibre having dimensions of 100 μm by 50 μm. Referring to FIG. 9, with dopant concentrations of rare-earths (such as Neodymium) of a few mole %, and utilizing either large cores 4 or multiple cores 4 (see FIGS. 3 to 6), good absorption of the pump radiation 2 is possible in lengths 98 of untapered preform 99 of 1 cm to 10 cm, but preferably 2 cm to 5 cm. Higher launched power can be achieved by imaging the pump radiation 2 from more laser diode modules 91 onto the first end 7 in smaller spots (with higher numerical apertures).

With practical preform technologies, the width 101 can be in the range 0.1 mm to 100 mm, the breadth in the range 0.1 mm to 100 mm and the length 98 in the range 1 mm to 2000 mm. The technology lends itself to immediate application with the width 101 in the range 0.2 mm to 25 mm, breadth 102 in the range 0.2 mm to 25 mm, and length 99 in the range 10 mm to 200 mm. Preferably, the width 101 will be in the range 5 mm to 15 mm, breadth 102 in the range 2 mm to 15 mm, and length 99 in the range 10 mm to 50 mm. The ratio of linear cross-sectional dimensions of the first end 6 to the second end 7 can be in the range 2 to 1000, and preferably in the range 10 to 250. By width 101 and breadth 102, it is meant two representative cross-sectional measures across the cross-section 100. The cross-section 100 can be rectangular, circular, square, D-shaped, or other regular or irregular shape. The preform can be made from silica, silicic, phosphate or phosphatic glasses. The preform may contain longitudinally extended holes (not shown) along its length as are found in microstuctured fibres, or stress rods such as are those used for inducing birefingence.

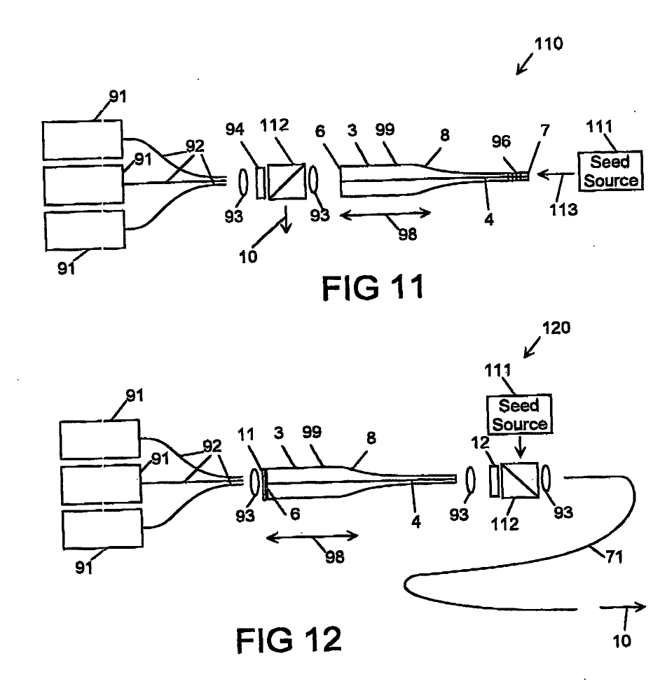

FIG. 11 shows apparatus in the form a of a master oscillator power amplifier (MOPA) 110 comprising a seed source 111 and a beam splitter 112. The beam splitter 112 is preferably dichroic. The seed source 111 may be a laser such as a fibre laser, a Q-switched laser, a pulsed laser, a femtosecond laser, or a semiconductor laser. The MOPA 110 is shown with the seed source 111 providing laser radiation 113 directed at the second end 7. This has the advantage that the brightness converter 3 will be less multi-moded at the second end 7 than the first end 6.

FIG. 12 shows apparatus in the form of a master oscillator power amplifier (MOPA) 120, which utilizes the brightness converter 3 to pump the waveguide 71. The brightness converter 3 may be doped with neodymium and/or ytterbium such that low-brightness 810 mm radiation is converted into laser radiation 10 having a higher brightness in a wavelength range that is absorbed by ytterbium (for example in the wavelength range 910 nm to 1050 nm, but preferably from 910 nm to 920 nm, 975 to 980 nm, or 1030 nm to 1050 nm). The waveguide 71 may be doped with ytterbium that is pumped by the laser radiation 10. Alternatively the waveguide 71 may be doped with erbium as discussed further with referenced to FIG. 7. The arrangement shown in FIG. 12 is advantageous for core-pumping the waveguide 71 because it allows higher output powers to be achieved before reaching non-linear effects. An intermediate fibre 81 (not shown) can also be used to enable the pump source 1 to be located remotely from the waveguide 71 as discussed with reference to FIG. 8.

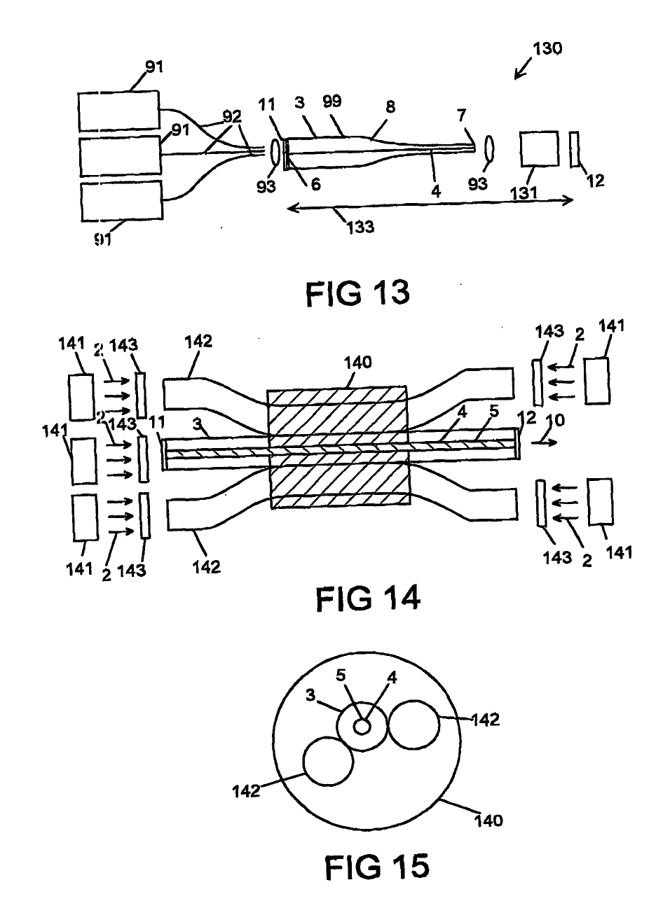

FIG. 13 shows apparatus in the form of a laser 130 that comprises a frequency converter 131 within the cavity 133 formed by the first reflector 11 and the second reflector 12. The frequency converter 131 may be a frequency doubler, a frequency tripler or a frequency quadrupler. The brightness converter 3 may be doped with neodymium and/or ytterbium. The first and second reflectors 11, 12 may be such that they reflect at the fundamental wavelength of the laser 130 (typically from 910 nm to 1100 nm).The frequency converter 131 may utilize a crystal such as barium titanate or lithium niobate for the frequency conversion.

FIG. 14 shows a plurality of minibar stacks 141 each of which are coupled into optical fibres 3, 142 using lens 143. The lens 143 may comprise a combination of a cylindrical and spherical lens configured to equalise the far field divergence angle (of the pump radiation 2 in orthogonal directions and to couple it efficiently into the optical fibres 142. The optical fibres 3, 142 have a common coating 140 and are in optical contact along at least a portion of their length—see FIG. 15—such that pump power launched in optical fibres 142 couple into and pump the brightness converter 3. The optical fibres 142 can be tapered or untapered. The optical fibres 3, 142 and can have circular, non-circular, square, or rectangular cross-sections. Non-circular cross sections assist in reducing the length over which the pump radiation is absorbed in the optical fibre 3. Increasing the optical contact between the optical fibres 3 and 142 by use of flat surfaces increase optical coupling between the fibres 3, 142. The examples provided in FIGS. 9 to 15 are based on fibre coupled laser modules 92. The brightness converters 3 described in these examples are also suited for simple coupling to either laser diode bars, laser diode stacks, or laser diode mini-bar stacks. These can be combined together or used separately, and can be continuous wave or pulsed. Examples are continuous wave laser diode stacks and bars with output powers of 10 W to 1 kW or more, and laser diode stacks that can instantaneous pulsed powers in excess of 1 kW or more. The laser diode stacks or bars can be water cooled and/or air cooled. Minibar stacks may comprise up to 9 diodes per bar and up to 12 bars in a stack. These may supply as much as 200 W pump radiation or more.

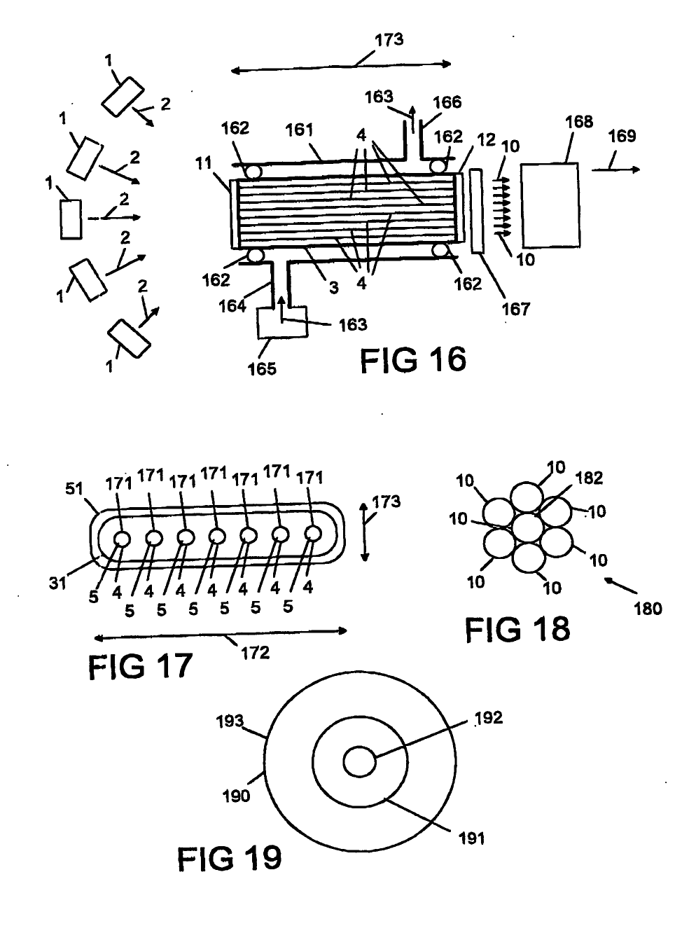

FIGS. 16 to 19 show a preferred embodiment of the invention. The beam combiner 3 has a substantially rectangular cross-section as shown in FIG. 17, and comprises a plurality of cores 4 arranged in at least one row. The cores 4, first and second claddings 31, 51 are formed from glass with the refractive index of the core 4 being higher than the refractive index of the first cladding 31 which is higher than the refractive index of the second cladding 51. The first cladding 31 may be formed on pure silica, and the second cladding 51 be formed from fluorosilicate glass.

With reference to FIG. 16, the beam combiner 3 is shown as having the first and second reflectors 11, 12 which may be fibre Bragg gratings that are formed in the cores 4. An advantage of having the cores 4 in a row is that it facilitates the writing of fibre Bragg gratings using ultra violet light. This is because the cores 4 can be located at the same focal length from a phase mask in a fibre Bragg grating writing apparatus such as described in U.S. Pat. No. 6,072,926. The cores 4 preferably have a photosensitive region 171 (shown in FIG. 17) such that fibre Bragg gratings can be written in them to form the first and second reflectors 11, 12 (shown as a reflectors in FIG. 16). The cores 4 may be formed in two rows, with the second row being formed by turning the beam combiner 3 around.

FIG. 16 also shows a plurality of pump sources 1 that are arranged to launch pump radiation 2 into the first cladding 31. Preferably the pump sources 1 comprise a plurality of diodes stacks, diode mini-stacks, diode bars or single emitters that are arranged geometrically or with beam combiners to couple the pump energy into the first cladding 31. Diode stacks and bars typically emit a highly rectangular output beam. Such a rectangular output beam can be readily coupled to the rectangular beam converter 3 shown in FIG. 17 without incurring the losses incurred by beam shapers incurred in launching pump radiation 2 from diode stacks into conventional optical fibres.

Optionally, the brightness converter 3 can be cooled by fluid 163 as shown in FIG. 16. The fluid is pumped into an enclosure 161 via an input port 164 from a fluid source 165 such as a pump, and the fluid 163 exits via an exit port 166. Seals 162 are provided between the enclosure 161 and the beam converter 3. The seals 162 may comprise O-rings. The fluid 163 may be a gas such as nitrogen or argon. The fluid 163 may alternatively be a fluid comprising water, oil, glycol, or a mixture of water and glycol. Fluid cooling is a highly effective way of removing heat from a high power laser and is facilitated by the rigidity of the beam converter 3, the absence of a polymer coating, and by the presence of the second cladding 51. Such fluid cooling would be difficult to implement in a fibre laser having a flexible fibre because of reliability concerns involved in removing a relatively thin fibre's polymer coating and surrounding the fibre in fluid.

An optional lens array 167 provides collimation of the output radiation 10. In order to provide optimal beam quality, the lens array 167 should be positioned so that the diffracting laser radiation 10 from each of the cores 4 just meets. Thus allowing a beam shaper 168 to combine the individual beams 10 in order, to provide a composite output beam 169. If there are seven cores 4, then the composite output beam 169 will have the beam profile 180 shown in FIG. 18. Such abeam 169 will have three times the beam parameter product of the output beam 10 from one of the cores 4. If the collimation provided by the lens array 167 and beam shaper 168 leaves gaps between the individual beams 10, then the beam quality of the composite output beam 169 will be degraded. The composite beam 169 can be launched into an optical fibre 190 for delivery to the point of use (not shown). The optical fibre 198 is preferably designed to be a step index fibre having a core 191 having the same or higher numerical aperture as the cores 4. If the central beam 182 in FIG. 8 is not present, then the optical fibre 190 can have a central region 192 having the same or lower refractive index as the cladding 193. The optical output from such a ring-doped fibre would have a doughnut optical power distribution, and thus would be advantageous for cutting applications because it would have similar cuffing power as an equivalent (ie same localised optical intensity) but higher total-power optical output having a top hat near-field distribution.

If seven cores 4 are used such as shown in FIG. 17, then the composite beam 169 would have a beam parameter product approximately three times greater than the beam parameter product of the cores 4. Thus if the wavelength of the optical radiation is in the range 1 μm to 1.1 μm, and the cores 4 are single moded, then the beam parameter product of the composite beam 169 would be approximately 1 mm·mrad. Additional cores 4 can thus be used to provide a high power laser having a beam parameter product in the range 3 mm·mrad to 25 mm·mrad. Alternatively or additionally, the cores 4 can be multimoded.

With referenced to FIG. 17, the beam converter 3 can have a width 171 between 2 mm and 20 mm, and a height 172 between 0.1 mm and 5 mm. The length 175 (shown in FIG. 16) of the beam converter 3 should preferably be such that the pump radiation 2 is absorbed. Suitable lengths 175 may be between 5 mm and 1000 mm, and preferably 10 mm to 20 mm. Note that the higher the ratio of the combined areas of the cores 4 to the cross-sectional area of the first cladding 31 the shorter the beam converter 3 can be. The beam converter 3 shown in FIG. 17 can be made by drawing down a rare-earth doped optical fibre preform into rods and inserting the rods into a silica substrate tube that has been drilled to accept the rods to form a composite preform. The composite preform can then be drawn on a fibre drawing tower.

The preferred embodiment shown in FIGS. 16 to 18 can be used with any of the configurations shown in FIGS. 1, 2, 6, 7, and 8. Thus for example, the apparatus of FIG. 16 can have a beam converter 3 that is tapered, can form part of a master oscillator power amplifier, and can have intermediate pump delivery fibres 92.

It is to be appreciated that the embodiments of the invention described above with reference to the accompanying drawings have been given by way of example only and that modifications and additional components may be provided to enhance performance. In addition, the invention can be considered to be a laser, a Q-switched fibre laser, a master oscillator power amplifier, or a laser that contains a frequency converter.

The present invention extends to the above-mentioned features taken in isolation or in any combination.

1-34. (canceled)

35. Apparatus for providing optical radiation, comprising a pump source for providing pump radiation, and a brightness converter, and wherein the brightness converter is defined by a length, and contains a substantially rigid region along at least a portion of the length.

36. Apparatus according to claim 35 wherein the brightness converter comprises a core, a first cladding, and rare earth dopant, and is defined by a first end and a second end.

37. Apparatus according to claim 36 wherein the brightness converter comprises a tapered region located between the first end and the second end, the apparatus further being defined by a cross-sectional area of the first end and a cross-sectional area of the second end, and further wherein the cross-sectional area of the first end is greater than the cross-sectional area of the second end, and the brightness converter is substantially rigid between the first end and the tapered region.

38. Apparatus according to claim 35, and wherein the pump radiation is coupled from the pump source into the brightness converter using a coupling means.

39. Apparatus according to claim 38 wherein the coupling means is a lens.

40. Apparatus according to claim 36 wherein the apparatus comprises a first reflector for reflecting optical radiation emerging from the first end.

41. Apparatus according to claim 40 and including a second reflector.

42. Apparatus according to claim 35 wherein the pump source comprises at least one laser diode, at least one laser diode bar, at least one laser diode stack, or at least one laser diode mini-bar stack.

43. Apparatus according to claim 35 wherein the pump source includes a solid-state laser, a gas laser, an arc lamp, or a flash lamp.

44. Apparatus according to claim 35 wherein the apparatus comprises a plurality of the pump sources and a combining means for combining pump radiation emitted by the pump sources.

45. Apparatus according to claim 44 wherein the combining means comprises a beam splitter, a reflector, a polarisation beam combiner, a beam shaper, a wavelength division multiplexer, or a plurality of optical fibres in optical contact along at least a portion of their length.

46. Apparatus according to claim 35 wherein the brightness converter contains a plurality of cores.

47. Apparatus according to claim 35 wherein the brightness converter contains a single core.

48. Apparatus according to claim 35 wherein the brightness converter is circular.

49. Apparatus according to claim 35 wherein the brightness converter is non-circular.

50. Apparatus according to claim 35 wherein the brightness converter comprises a rare-earth dopant.

51. Apparatus according to claim 50 wherein the rare earth dopant is selected from the group comprising Ytterbium, Erbium, Neodymium, Praseodymium, Thulium, Samarium, Holmium, Dysprosium, Erbium codoped with Ytterbium, or Neodymium codoped with Ytterbium.

52. Apparatus according to claim 36 wherein the brightness converter comprises a second cladding.

53. Apparatus according to claim 35 wherein the brightness converter is doped with neodymium or ytterbium, and the waveguide is doped with ytterbium, erbium, or erbium co-doped with ytterbium.

54. Apparatus according to claim 35 comprising a waveguide that is pumped by the brightness converter.

55. Apparatus according to claim 35 wherein the brightness converter is defined by a width, and wherein the width is in the range 0.1 mm to 100 mm.

56. Apparatus according to claim 55 wherein the width is in the range 0.2 mm to 25 mm.

57. Apparatus according to claim 56 wherein the width is in the range 5 mm to 15 mm.

58. Apparatus according to claim 35 wherein the brightness converter is defined by a breadth, and wherein the breadth is in the range 0.1 mm to 100 mm.

59. Apparatus according to claim 58 wherein the breadth is in the range 0.2 mm to 25 mm.

60. Apparatus according to claim 59 wherein the breadth is in the range 2 mm to 15 mm.

61. Apparatus according to claim 1 wherein the brightness converter is defined by a length, and wherein the length is in the range 1 mm to 2000 mm.

62. Apparatus according to claim 61 wherein the length is in the range 10 mm to 200 mm.

63. Apparatus according to claim 62 wherein the length is in the range 10 mm to 50 mm.

64. Apparatus according to claim 35 wherein the brightness converter is formed from an optical fibre preform.

65. Apparatus according to claim 64 wherein the preform is made from silica, silicic, phosphate or phosphatic glass.

66. Apparatus according to claim 64 wherein the preform defines longitudinally extended holes disposed therein.

67. Apparatus according to claim 66 wherein the preform includes stress rods.

68. Apparatus according to claim 35 and in the form of a laser, a Q-switched fibre laser, a master oscillator power amplifier, or a laser that contains a frequency converter.
